(19) United States
(12) Patent Application Publication
(10) Pub. No.: US 2002/0002587 A1
(43) Pub. Date: Jan. 3, 2002

(54) Method and Arrangement for Determining Current Projection Data for a Projection of a Spatially Variable Area

(75) Inventors: Mr. Yalin Ahmet Kecik, Muenchen (DE); Mr. Thomas Ruge, Muenchen (DE); Mr. Claus Peter Wiedemann, Ottobrunn (DE)

Correspondence Address: Schiff Hardin & Waite, Mark Bergner, 6600 Sears Tower, Chicago, Illinois, 60606, US, mbergner@schiffhardin.com, (312)258-5779, (312)258-5700

(73) Assignee: Siemens Aktiengesellschaft, Muenchen, 80333 (DE)

(21) Appl. No.: 09/652,671

(22) Filed: Aug. 31, 2000

(30) Foreign Application Priority Data
Jul. 17, 2000 (DE) 10034697.9

(51) Int. Cl. G06F 15/16

(52) U.S. Cl. 709/206

(57) ABSTRACT

### Abstract of Disclosure

In a method and the arrangement for determining projection data for a projection of a spatially variable area, change data are determined in a first computing unit, where the change data describe a change in the spatially variable area from a starting state to an end state. The change data are transmitted to a second computing unit and to a third computing unit, which are each connected to the first computing unit. First current projection data for a first projection of the spatially variable area are determined in the second computing unit using the change data and first previously stored projection data. Second current projection data for a second projection of the spatially variable area are determined in the third computing unit using the change data and second previously stored projection data.

### Background of Invention

### Field of the Invention

The invention relates to the determination of current projection data for a projection of a spatially variable area.

### Description of the Related Art

Projection data for a projection of a spatially variable area are usually determined in a 3D projection system, for example, a "virtual reality"system (VR-system) or a "visual simulation"system (VSin order to represent images or image sequences three-dimensionally.

Such a 3D projection system is disclosed in Brochure sheet "Personal Immersion", Frauenhofer-Institut fur Arbeitswirtschaft und Organisation (IAO), 06/2000, Stuttgart, Germany and is illustrated in Fig. 2. According to Fig. 2, the 3D projection system 200 has a multi-node architecture which connects two individual computers 210, 220, to form an overall system. The two individual computers 210, 220 are connected to one another via an Ethernet network data line 230. Furthermore, the two individual computers 210, 220 are connected to a respective projection unit 240, 250.

In order to perform an interaction between a user and the 3D projection system 200, the first individual computer 210 is connected to an input device, namely a mouse 260, and a position tracking system 270. The position tracking system 270 serves to transmit an action on the part of the user in a real environment/world into a virtual world of the 3D projection system 200. Seen objectively, then, this position tracking system 270 is an interface between the real world of a user and the virtual world of the 3D projection system 200.

In the multi-node architecture of the 3D projection system 200, the first individual computer 210 performs a control and monitoring task, for example, a synchronization of three-dimensional image data which are determined in the first individual computer 210 and the second individual computer 220 and transmitted to the respective projection unit 250, 260 connected to the individual computer, to form a synchronized projection.

In order to determine the three-dimensional image data, an exemplary 3D projection system 200 uses a software program "Lightning", a product produced by Fraunhofer IAO in Stuttgart which is marketed and has extensions developed by CENIT AG Systemhaus. The latter is executed under the known Linux operating system installed on each of the individual computers 210, 220. For visualization of the three-dimensional image data, the software program "Lightning"uses a program library "Performer", which is produced by SGI™located in California, USA.

In this multi-node architecture of the 3D projection system 200, the first individual computer, in addition to determining the three-dimensional image data, also performs the control and monitoring of the 3D projection system 200. For this reason, in the 3D projection system 200, the requirement for computing power that is imposed on the first individual computer is more stringent than that imposed on the second individual computer.

When two identical individual computers 210, 220 are used, the extent to which the capacity of these computers is utilized is different (asymmetrical). In this case, however, at least one individual computer 210, 220 operates inefficiently.

As an alternative, it is possible to use two individual computers 210, 220 which are specifically matched to the respective computing power that is required. However, procurement costs and maintenance costs are higher for these specially matched individual computers 210, 220.

### Summary of Invention

The invention is thus based on the problem of specifying a method and an arrangement which make it possible to determine projection data for a 3D projection in a simple and cost-effective manner.

The problem is solved a method for determining current projection data for a projection of a spatially variable area, comprising the steps of: determining change data in a first computing unit, the change data describing a change in the spatially variable area from a starting state to an end state; transmitting the change data to a second computing unit and to a third computing unit, the second and the third computing units each being connected to the first computing unit; determining first current projection data for a first projection of the spatially variable area in the second computing unit using the change data and first previously stored projection data; and determining second current projection data for a second projection of the spatially variable area in the third computing unit using the change data and second previously stored projection data.

The problems is also solved with an arrangement for determining current projection data for a projection of a spatially variable area, comprising: a first computing unit configured to determine change data which describe a change in the spatially variable area from a starting state to an end state; a second computing unit configured to receive the change data transmitted to it and connected to the first computing unit, and configured to determine first current projection data for a first projection of the spatially variable area using the change data and first previously stored projection data; and a third computing unit configured to receive the change data transmitted to it and connected to the first computing unit, and configured to determine second current projection data for a second projection of the spatially variable area using the change data and second previously stored projection data.

In the case of the method for determining current projection data for a projection of a spatially variable area, change data are determined in a first computing unit. This change data describes a change in the spatially variable area from a starting state to an end state. The change data are transmitted to a second computing unit and to a third computing unit, which are each connected to the first computing unit.

First current projection data for a first projection of the spatially variable area are determined in the second computing unit using the change data and first previously stored projection data. Second current projection data for a second projection of the spatially variable area are determined in the third computing unit using the change data and second previously stored projection data.

The arrangement for determining current projection data for a projection of a spatially variable area has a first computing unit, which is set up in such a way that change data can be determined which describe a change in the spatially variable area from a starting state to an end state, and the change data can be transmitted to a second computing unit and to a third computing unit, which are each connected to the first computing unit.

The second computing unit is set up in such a way that first current projection data for a first projection of the spatially variable area can be determined using the change data and first previously stored projection data. The third computing unit is set up in such a way that second current projection data for a second projection of the spatially variable area can be determined using the change data and second previously stored projection data.

Seen objectively, the arrangement according to the invention has a symmetrical structure resulting from the fact that the second computing unit and the third computing unit each perform mutually corresponding method steps. This leads to symmetrical, and hence efficient, utilization of the capacity of the second and third computing units.

A further particular advantage of the invention is that components of the invention can be realized by commercially available hardware components, for example, by commercially available PCs. This means that the invention can be realized in a simple and cost-effective manner. Furthermore, low maintenance costs are incurred with such a realization.

A further advantage is that the arrangement according to the invention can be expanded simply and flexibly, (i.e., it is scalable), for example, by additional second and/or third computing units.

Furthermore, the invention has the particular advantage that it is independent of a computing platform and can be integrated in a simple manner into any desired known projection and/or visualization systems, for example, the above-mentioned "Lightning", "Vega", a product provided by Multigen-Paradigm, Inc., headquartered in San Jose, California, USA, and "Division". The procurement costs of the new projection systems and/or visualization systems which are thus realized are considerably lower than those of the original systems.

The arrangement is particularly suitable for carrying out the method according to the invention or one of its developments explained below. The inventive developments described below relate both to the method and to the arrangement. These inventive developments can be realized in software and in hardware, for example, using a specific electrical circuit. Furthermore, the invention or a development described below can be realized by way of a computer- readable storage medium on which is stored a computer program which executes the invention or development. Moreover, the invention and/or any development described below can be realized by a computer program product having a storage medium on which is stored a computer program which executes the invention and/or development.

The invention furthermore has the particular advantage that it is expandable or scalable in a particularly simple manner and can thus be used extremely flexibly. In one expansion, the arrangement is equipped with a plurality of second and/or third computing units, each of which is connected to the first computing unit.

By virtue of the transmission of only the change data to the second and third computing units and the subsequent reconstruction of the data which describe the spatially variable area in the second and third computing units in each case from the change data instead of a determination of the data which describe the spatially variable area, in the second and third computing units, the volume of transmission data and the computing power required in a computing unit are considerably reduced.

This makes it possible, in one refinement of the invention, to realize the arrangement using standard hardware components. Thus, by way of example, the first computing unit, the second computing unit and the third computing unit may be realized by a commercially available PC in each case.

In one refinement, the first current and second current projection data are stored in the second and third computing units. In the event of a further, subsequent projection, the formerly current projection data are thus the previously stored projection data. In this case, the method is carried out recurrently.

The arrangement according to the invention is particularly well suited to a projection system for the projection of a three-dimensional image (3D image) or of an image sequence comprising 3D images, for example, in a virtual reality system and/or visual simulation system. In this case, the spatially variable area is contained in the 3D images which are generated by the virtual reality system and/or the visual simulation system.

One development of the invention relating to such a projection system has a first projection unit for the first projection and a second projection unit for the second projection, the first projection unit being connected to the second computing unit and the second projection unit being connected to the first computing unit.

Qualitatively good projection of the spatially variable area is achieved when the projections of the projection units are synchronized, e.g., by the transmission of a synchronization information item from the first computing unit, in each case to the second and the third computing unit. This synchronization is realized in a particularly simple manner by a broadcast mechanism in which the first computing unit transmits a broadcast message to the second and third computing units.

The projection is improved further if the determination of the first projection data and the determination of the second projection data are also synchronized. To that end, the first computing unit transmits a first synchronization information item to the second computing unit and a second synchronization information item to the third computing unit. The processes of determining the first and the second projection data are synchronized using the first and the second synchronization information item. This synchronization can also be realized in a simple manner by a broadcast mechanism.

Integration of known methods for the projection of a spatially variable area into one refinement of the invention can be realized in a particularly simple manner when the spatially variable area is described by a scene graph. In this case, the change is determined from a change in the scene graph in the spatially variable area in the starting state with respect to the scene graph of the spatially variable area in the end state.

In the event of the projection of 3D images of a 3D image sequence, the spatially variable area is contained in each case in a 3D image of the 3D image sequence. In this case, the scene graph is determined for each 3D image of the 3D image sequence.

In one development of the invention, an initialization is carried out, in which initialization data describing the spatially variable area in an initialization state are transmitted to the second and third computing units and first initialization projection data are determined in the second computing unit using the initialization data and second initialization projection data are determined in the third computing unit using the initialization data.

### Brief Description of Drawings

Exemplary embodiments of the invention are illustrated in figures and are explained in more detail below.

Figure 1 is a block diagram showing a VR system in accordance with a first exemplary embodiment;

Figure 2 is a block diagram showing of a 3D projection system in accordance with the prior art;

Figure 3 is a flowchart illustrating the method steps which are carried out during a 3D projection;

Figure 4 is a block diagram illustrating software architectures for a 3D projection system in accordance with a first and second exemplary embodiment; and

Figure 5 is a functional block diagram of a 3D projection system in accordance with a second exemplary embodiment.

### Detailed Description

### First exemplary embodiment: VR system

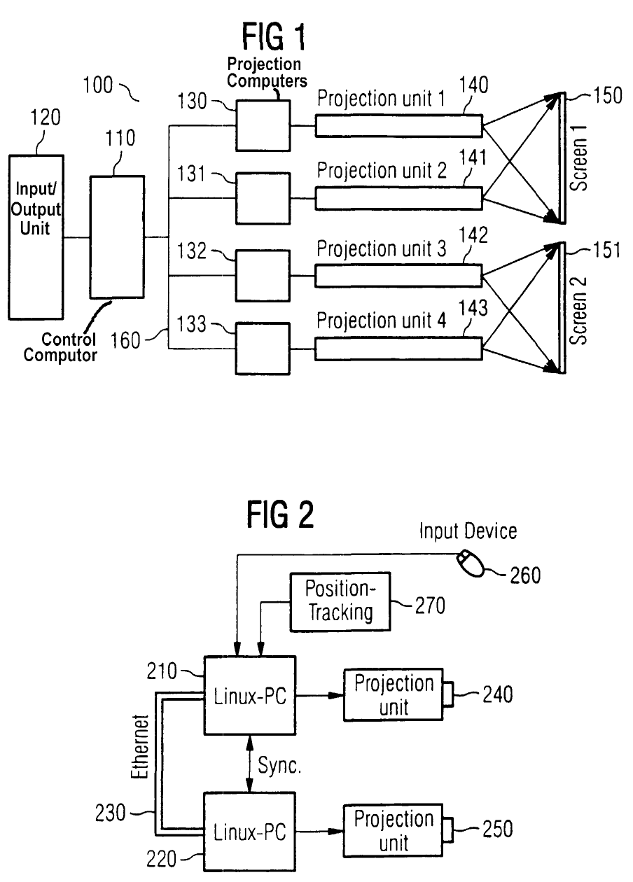

Figure 1 shows a "virtual reality" system (VR system) having a networked computer architecture 100 for the visualization of 3D scenes. In this networked computer architecture 100, a control computer (master) 110 is connected to an input/output unit 120 and to four projection computers (slaves) 130, 131, 132, 133.

Each projection computer 130, 131, 132, 133 is further connected to a projector 140, 141, 142, 143. In each case one projection computer 130, 131, 132, 133 and the projector 140, 141, 142, 143 connected to the respective projection computer 130, 131, 132, 133 together form a projection unit. In each case, two of these projection units are set up for projecting a 3D image onto a projection screen 150, 151. Accordingly, the VR system has two such projection screens 7150, 151.

A data network 160, via which the components of the networked computer architecture 100 are connected, may be implemented using a commercially available Ethernet network. The control computer 110 and the projection computers 130, 131, 132, 133 are each equipped with an Ethernet network card and corresponding Ethernet network software. Both the control computer 110 and the projection computers 130, 131, 132, 133 may be commercially available Intel Pentium III PCs, and the projection computers 130, 131, 132, 133 are each additionally equipped with a 3D graphics card.

A Linux operating system may be, in each case, installed on the control computer 110 and on the projection computers 130, 131, 132, 133. The projectors 140, 141, 142, 143 may be commercially available LCD or DLP projectors.

A virtual reality application software, such as the "Vega"application software, as described in the product brochure "Vega™: The Comprehensive Software Environment for Realtime Application Development Product Catalog" produced by MultiGen Paradigm, Inc. of San Hose, California, herein incorporated by reference, and a 3D graphics library, such as the "SGI Performer", Version 2.3, may be installed on the control computer 110. The 3D graphics library "SGI Performer"Version 2.3, may likewise installed on each projection computer 130, 131, 132, 133.

Furthermore, executable software is, in each case, installed on the control computer 110 and the projection computers 130, 131, 132, 133, which software can be used to carry out method steps described below during visualization of 3D scenes.

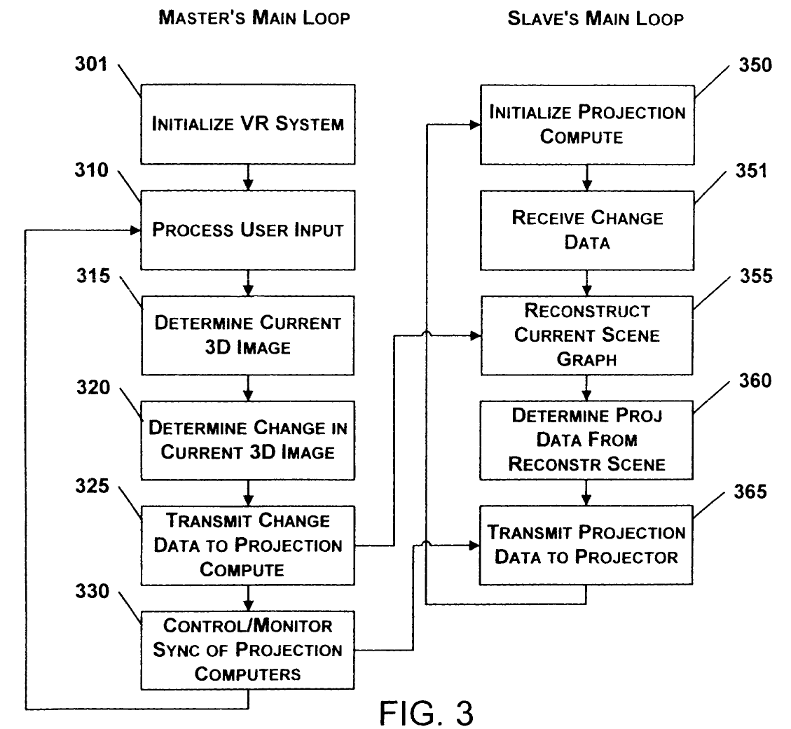

Fig. 3 illustrates the method steps during the visualization of 3D scenes. The method steps 301, 310, 315, 320, 325 and 330 are executed by the software installed on the control computer 110. The method steps 350, 351, 355, 360 and 365, are, in each case, executed on all of the projection computers 130, 131, 132, 133 by the software installed there.

The method steps 350, 351, 355, 360, 365 are described by way of example for a projection computer 130, 131, 132, 133. They are, however, executed in a corresponding manner on all the other projection computers 130, 131, 132, 133.

All spatial information in 3D images in the VP. system 100 is described by a "scene graph" which is described in the technical document IRIS Performer: Real-Time 3D Rendering for High Performance and Interactive Graphics Applications, Silicon Graphics, Inc. Mountain View, California, 1998, Doc. No. 007-3634-001 (IRIS Performer White Paper), herein incorporated by reference.

Arrows interconnecting method steps in Fig. 3 illustrate a temporal sequence of the respectively connected method steps. The VR system is initialized in an initialization method step 301 of the control computer 310 and an initialization method step 350 of a projection computer 130, 131, 132, 133. In this case, a 3D initialization image is determined in the control computer 110 using the "vega" application software and transmitted to the projection computers 130, 131, 132, 133.

Furthermore, mapping parameters are determined during the initialization of the VR system, which parameters establish an interactive connection between a real world of a user and a virtual world of the VR system 100. Using these mapping parameters, actions which are executed by the user in the real world can be transmitted as a corresponding image sequence into the virtual world of the VR system 100.

In a method step 310, a user input is processed in the control computer 110. In this case, an action on the part of the user in the real world is transmitted into the virtual world of the VR system 100. The control computer 110 subsequently determines the current 3D image in a method step 315.

In a method step 320, a change in the current 3D image relative to a chronologically preceding 3D image which was determined and stored in the control computer is determined. This is done by determining a change in the scene graph in the current 3D image relative to the scene graph in the chronologically preceding 3D image. Seen objectively, in this case, a difference is determined between the current scene graph and the chronological preceding scene graph (change data).

In a method step 325, the change data are transmitted to a projection computer 130, 131, 132, 133. In a method step 330, the control computer 110 controls and monitors a synchronization of the projection computers 130, 131, 132, 133, which synchronization is described separately below.

Afterward, the control computer 110 can again process a new action on the part of the user, the method steps 310, 315, 320, 325, 330 again being carried out as described.

In a method step 351, a projection computer 130, 131, 132, 133, receives the change data (cf. method step 325). In a method step 355, the current scene graph is "reconstructed" in the projection computer 130, 131, 132, 133, using the change data and a scene graph of a chronologically preceding 3D image. In a method step 360, projection data are determined from the reconstructed scene graph using the 3D graphics library "SGI Performer", version 2.3. Finally, in a method step 365, the projection data are transmitted to a projector 140, 141, 142, 143 and projected. This transmission to the respective projector 140, 141, 142, 143 takes place in a synchronized manner at all the projection computers 130, 131, 132, 133.

### Synchronization

Double synchronization is effected in the VR system 100 as illustrated in Fig. 1.

The two synchronization processes are each carried out by a "broadcast mechanism", which is described in W. Richard Stevens, UNIX Network Programming, page 192, Prentice Hall 1990, herein incorporated by reference.

In the case of this broadcast mechanism, broadcast messages are transmitted to the projection computers 130, 131, 132, 133 by the control computer 110 in order to synchronize computer actions in the projection computers 130, 131, 132, 133. These transmitted broadcast messages correspond objectively to synchronization pulses which synchronize the computer actions. The transmission of the change data from the control computer 110 to the projection computers 130, 131, 132, 133 is synchronized in a first synchronization process.

In the projection computers 130, 131, 132, 133, the current scene graph is determined in each case and the corresponding projection data for the projection of a 3D image are determined. The projection data are stored in a special memory of a projection computer 130, 131, 132, 133.

As soon as the projection data have been determined in a projection computer 130, 131, 132, 133, a message is transmitted from the respective projection computer 130, 131, 132, 133, to the control computer 110. The projection computer 130, 131, 132, 133, thereby "informs"the control computer 110 that it is ready for the subsequent projection.

As soon as the control computer 110 has received the communications from all of the projection computers 130, 131, 132, 133, it synchronizes the subsequent projection (second synchronization process).

This second synchronization process is likewise effected by broadcast messages which are transmitted from the control computer 100 to the projection computers 130, 131, 132, 133.

Seen objectively, the control computer 110 "requests"the projection computers 130, 131, 132, 133 to transmit the projection data from the special memories simultaneously to the projectors for projection.

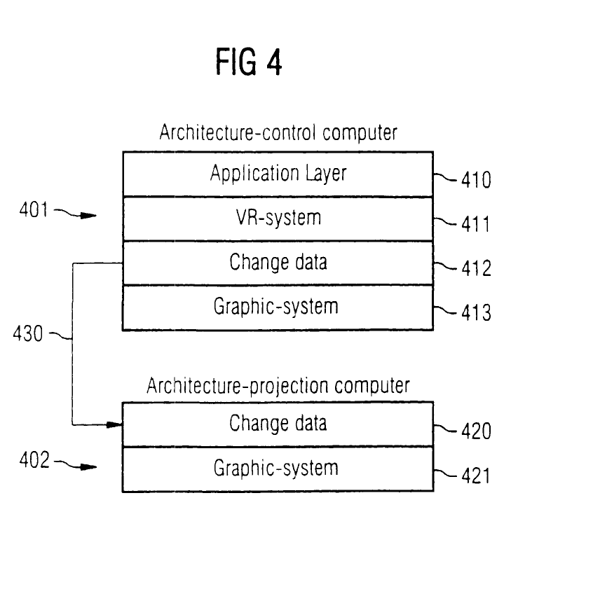

Fig. 4 illustrates a software architecture of the control computer 401 and also a software architecture of a projection computer 402 in each case via a layer model having hierarchically ordered layers. The layer model described below in a representative manner for a projection computer is realized as described in all of the projection computers.

A layer in this model means a software module which offers a service to a layer that is superordinate to it. The software module of the layer may at the same time use a service of a layer that is subordinate to it. Each layer provides an API (Application Programming Interface) which defines available services and formats of input data for these available services.

The software architecture of the control computer 401 has a first, topmost layer, an application layer 410. The application layer 410 is the interface to the user. The second layer 411, which is subordinate to the first layer 410, is the VR system, where the 3D data are generated, managed and transferred as a scene graph to the 3D graphics library exemplified by "SGI Performer", version 2.3, for visualization. In a third layer 412, which is subordinate to the second layer 411, the change data describing a change in a scene graph in two chronologically succeeding scenes are determined and communicated to a corresponding layer 420 in the projection computers. In the fourth layer 413, data of the 3D graphics library exemplified by "SGI Performer", version 2.3, are stored. The visualization is effected in this layer.

The software architecture of a projection computer 402 comprises two layers. In the first layer 420, the change data describing a change in a scene graph in two chronologically succeeding scenes are received and forwarded to the 3D graphics library exemplified by "SGI Performer", version 2.3. In the second layer 421, which is subordinate to the first layer, data of the 3D graphics library, "SGI Performer"version 2.3 are stored.

A connecting arrow 430, which connects the third layer of the software architecture of the control computer 412 to the first layer of the software architecture of the projection computer 420, illustrates that data which are transmitted from the control computer to a projection computer are exchanged between these layers.

### Second exemplary embodiment: VR System

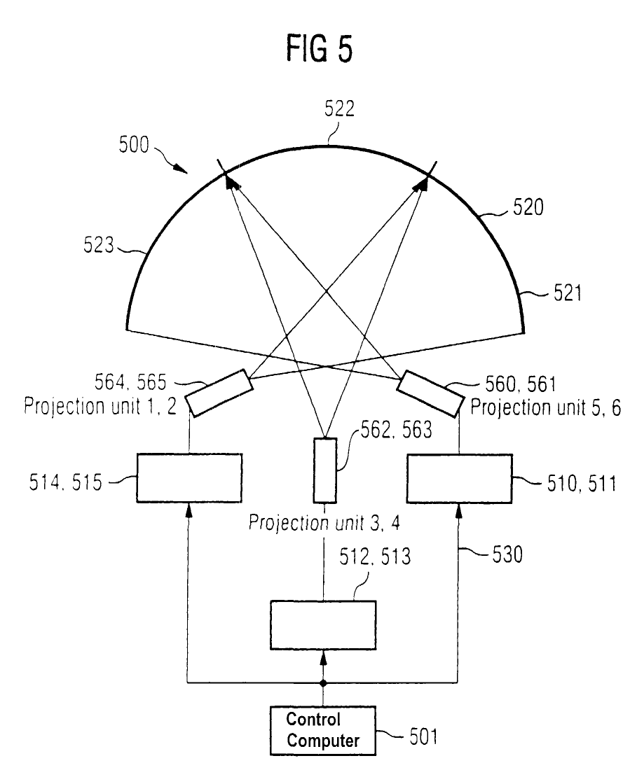

Fig. 5 shows a second, virtual reality, system (VR system) 500 having a networked computer architecture for the visualization of 3D scenes. In this networked computer architecture, a control computer (Master) 501 is connected to six projection units 510, 511, 512, 513, 515 in accordance with the first exemplary embodiments. In a manner corresponding to the first exemplary embodiment, in each case two of these projection units 510, 511, 512, 513, 514, 515 are set up for projecting a 3D image onto a projection screen 520. The three projection screens 521, 522, 523 that are necessary in this case are arranged such that they are adjacent in a semicircle and thus provide a user with "panoramic view".

The data network 530, which connects the components of the networked computer architecture, the control computer 501, the projection computers 510, 511, 512, 513, 514, 515, and projectors 560, 561, 562, 563, 564, 565 are realized in a manner corresponding to the first exemplary embodiment. The software of the control computer 501 and of the projection computers 510, 511, 512, 513, 514, 515 is also realized in accordance with the first exemplary embodiment. The method steps that were illustrated in Fig.3 350 and described in the context of the first exemplary embodiment are correspondingly executed in the case of the VR system 500 in accordance with the second exemplary embodiment.

The above-described method and communication system are illustrative of the principles of the present invention. Numerous modifications and adaptations thereof will be readily apparent to those skilled in this art without departing from the spirit and scope of the present invention.

Claims

1.A method for determining current projection data for a projection of a spatially variable area, comprising the steps of:
determining change data in a first computing unit, said change data describing a change in said spatially variable area from a starting state to an end state;
transmitting said change data to a second computing unit and to a third computing unit, said second and said third computing units each being connected to said first computing unit;
determining first current projection data for a first projection of said spatially variable area in said second computing unit using said change data and first previously stored projection data; and
determining second current projection data for a second projection of said spatially variable area in said third computing unit using said change data and second previously stored projection data.

2.The method as claimed in claim 1, further comprising the step of storing data selected from the group consisting of said first current projection data and said second current projection data.

3.The method as claimed in claim 1, further comprising the steps of:
transmitting, by said first computing unit, a first synchronization information item to said second computing unit; and
transmitting, by said first computing unit, a second synchronization information item to said third computing unit, said steps of transmitting said first and said second synchronization items being utilized for synchronizing processes for said step of determining said first and said second current projection data.

4.The method as claimed in claim 1, further comprising the steps of:
transmitting, by said first computing unit, a third synchronization information item to said second computing unit; and
transmitting, by said first computing unit, a fourth synchronization information item to said third computing unit, said steps of transmitting said third and said fourth synchronization items being utilized for synchronizing said first and said second projection.

5.The method as claimed in claim 3, wherein said first or said second synchronization information item is a broadcast message of a broadcast mechanism.

6.The method as claimed in one of claim 1, further comprising the step of:
initializing said method, wherein said initializing step comprises the steps of:
transmitting initialization data describing said spatially variable area in an initialization state to said second and said third computing units;
determining first initialization projection data in said second computing unit using said initialization data; and
determining second initialization projection data are determined in said third computing unit using said initialization data.

7.The method as claimed in claim 1, wherein said spatially variable area is described by a scene graph.

8.The method as claimed in claim 7, further comprising the step of:
determining said change in said spatially variable area from a change in said scene graph of said spatially variable area in said starting state with respect to said scene graph of said spatially variable area in said end state.

9.The method as claimed in claim 1, wherein said spatially variable area in said starting state or said spatially variable area in said end state is contained in a 3D image.

10.The method as claimed in claim 9, further comprising the steps of:
projecting 3D images of a 3D image sequence; and
determining said scene graph for each 3D image of said 3D image sequence.

11.The method as claimed in claim 10, further comprising the steps of:
generating 3D images using a system selected from the group consisting of a virtual reality system and a visual simulation system.

12. An arrangement for determining current projection data for a projection of a spatially variable area, comprising:
a first computing unit configured to determine change data which describe a change in said spatially variable area from a starting state to an end state;
a second computing unit configured to receive said change data transmitted to it and connected to said first computing unit, and configured to determine first current projection data for a first projection of said spatially variable area using said change data and first previously stored projection data; and
a third computing unit configured to receive said change data transmitted to it and connected to said first computing unit, and configured to determine second current projection data for a second projection of said spatially variable area using said change data and second previously stored projection data.

13. The arrangement as claimed in claim 12, further comprising:
a second computing unit connected to said first computing unit.

14. The arrangement as claimed in claim 12, wherein said first computing unit and said second computing unit are PCs.

15. The arrangement as claimed in claim 12, further comprising:
a first projection unit, which is connected to said second computing unit, and is set up for said first projection; and
a second projection unit, which is connected to said third computing unit and is set up for said second projection.

16.The arrangement as claimed in claim 12, wherein said first projection and said second projection are configured to be synchronized.

17.The method as claimed in claim 4, wherein said third or said fourth synchronization information item is a broadcast message of a broadcast mechanism.

18. The arrangement as claimed in claim 13, further comprising:
a third computing unit connected to said first computing unit.

19. The arrangement as claimed in claim 18, wherein said third computing unit is a PC.
